(19) United States
(12) Patent Application Publication
(10) Pub. No.: US 2005/0200330 A1
(43) Pub. Date: Sep. 15, 2005

(54) Battery locking apparatus

(75) Inventors: Kyoung-jin Ahn, Suwon-si (KR); Dong-seok Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/048,921

(22) Filed: Feb. 3, 2005

(30) Foreign Application Priority Data
Mar. 10, 2004 (KR) 2004-16029

(51) Int. Cl. H02J 7/00

(52) U.S. Cl. 320/112

(57) ABSTRACT

A battery locking apparatus to conveniently and easily separate a battery from an image photographing apparatus with one hand. The battery locking apparatus locks and releases a battery that is detachably mounted to the image photographing apparatus by a sliding operation of a sliding button. The releasing directions of the sliding button and the battery are opposite to each other.

### CROSS-REFERENCE TO RELATED APPLICATIONS

This application claims the benefit under 35 U.S.C. § 119(a) of Korean Patent Application No. 2004-16029, filed Mar. 10, 2004, in the Korean Intellectual Property Office, the entire disclosure of which is hereby incorporated by reference.

### BACKGROUND OF THE INVENTION

1. Field of the Invention

The present invention relates to an electronic device having a rechargeable battery. More particularly, the present invention relates to a battery locking apparatus removably mounted on the electronic device, such as a digital camera and a video camcorder.

2. Description of the Related Art

As portability of electronic devices has been emphasized, a rechargeable battery for supplying power to the electronic device has been introduced and popularized. Such a rechargeable battery is removably mounted inside or outside of the electronic device. When an inner space of the electronic device is not enough to accommodate the battery due to compactness, the rechargeable battery may be disposed on the outside of the electronic device. In this case, the electronic device is typically provided with a certain locking apparatus for locking or releasing the rechargeable battery selectively by a user.

Generally, the battery locking apparatus primarily fixes the battery in a sliding manner by lockers respectively formed on the electronics and the battery for engagement with each other. A dedicated locking apparatus is provided to secure the locked state of the battery.

However, with the above structure, releasing of the battery locking apparatus is inconvenient since the user needs to use both hands to grab the battery and release the battery locking apparatus. Therefore, an improved battery locking apparatus has been in demand for easier manipulation for replacing the rechargeable battery.

### SUMMARY OF THE INVENTION

Accordingly, an aspect of the present invention is to provide an improved battery locking apparatus for enabling a user to conveniently replace a rechargeable battery using one hand.

A battery locking apparatus locks and releases a rechargeable battery detachably mounted to an electronic device by a sliding operation of a sliding button, wherein releasing directions of the sliding button and the battery are opposite to each other.

The battery is mounted to a rear side of the electronic device and separated in a gravity direction.

According to another embodiment of the present invention, a battery locking apparatus includes a plurality of guide ribs protruding from a battery mounting frame connected to one side of an electronic device. A plurality of rib grooves corresponding to the guide ribs are adapted to engage the guide ribs in a sliding manner. A fixing member is formed at the battery mounting frame to appear and disappear by a user's selection, thereby restricting sliding movement of the battery. A sliding button moves the fixing member up and down. The sliding button is slid in the opposite direction to a releasing direction of the battery to separate the battery from the electronic device.

The fixing member is elastically supported by a fixing member holder that may be integrally formed with the battery mounting frame to slide according to the operation of the sliding button.

The fixing member holder has a guide groove for guiding the sliding movement of the fixing member.

The fixing member includes a fixing member body, and a fixing projection integrally formed with the fixing member body to restrict the sliding movement of the battery. A guide projection slides along the guide groove. A first slope contacts the sliding button to move up and down the fixing member body in a perpendicular direction to the movement of the sliding button.

The sliding button has a second slope contacting the first slope, and a sloping angle of the second slope being approximately the same as that of the first slope.

The battery mounting frame includes a switching unit for detecting whether the battery is mounted or not. The switching unit has a sensor plate vertically reciprocating as the battery slides. A sensor elastic member elastically supports the sensor plate. A supporting bracket fixes the sensor plate and moves in association with the reciprocation of the sensor plate. A micro switch mounted on a circuit board is connected to a rear side of the battery mounting frame and turned on and off by the supporting bracket.

Other objects, advantages and salient features of the invention will become apparent from the following detailed description, which, taken in conjunction with the annexed drawings, discloses preferred embodiments of the invention.

### BRIEF DESCRIPTION OF THE DRAWING FIGURES

The above aspect and other features of the present invention will become more apparent by describing in detail exemplary embodiments thereof with reference to the attached drawing figures, wherein;

FIGS. 1A and 1B are perspective views of an image photographing apparatus having a battery locking apparatus according to an embodiment of the present invention;

FIG. 2 is an exploded and perspective view of a battery mounting frame and a rechargeable battery constructing the battery locking apparatus according to an embodiment of the present invention;

FIG. 3 is a partially-enlarged side view of the battery locking apparatus of FIG. 2 showing a fixing member;

FIG. 4 is a rear view of a sliding button sliding in engagement with the fixing member of FIG. 3;

FIG. 5 is a perspective view of a switching unit mounted at an upper part of the battery mounting frame to determine whether the battery is mounted; and

FIG. 6 is a rear view of the switching unit of FIG. 5.

Throughout the drawings, like reference numerals will be understood to refer to like parts, components and structures.

### DETAILED DESCRIPTION OF EXEMPLARY EMBODIMENTS

Hereinafter, an embodiment of the present invention will be described in detail with reference to the accompanying drawing figures.

The matters defined in the description, such as a detailed construction and elements thereof, are provided to assist in a comprehensive understanding of the invention. Thus, it is apparent that the present invention may be carried out without those defined matters. Also, well-known functions or constructions are not described in detail for brevity and conciseness.

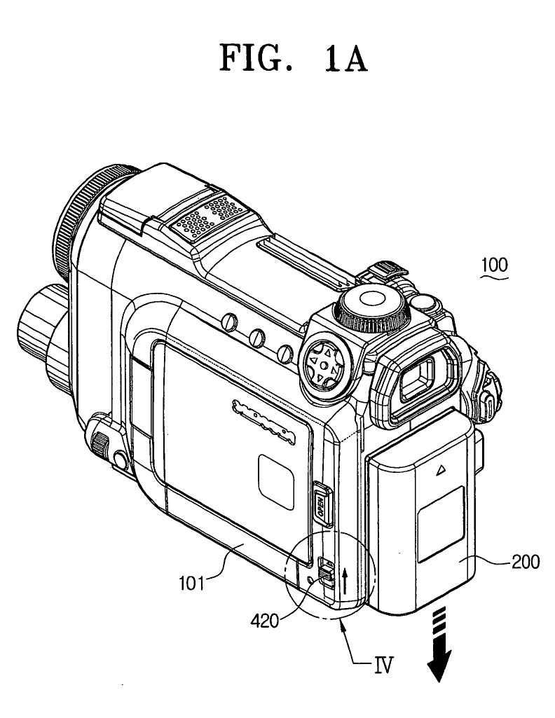

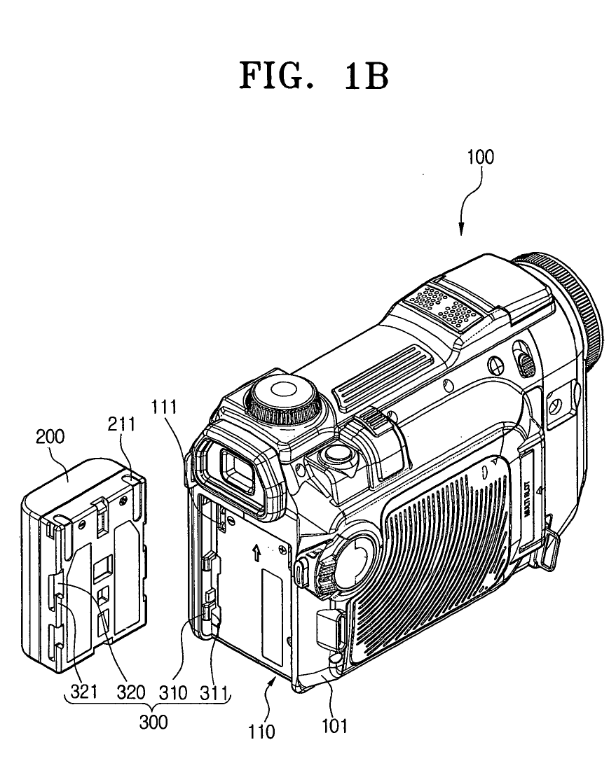

FIGS. 1A and 1B illustrate an image photographing apparatus having a battery locking apparatus according to an embodiment of the present invention.

An image photographing apparatus 100 mounts a detachable battery 200 at a rear side of a main body 101. Therefore, the main body 101 has a battery mounting frame 110 at the rear side thereof to receive the battery 200.

The battery mounting frame 110 includes a first terminal 111 to contact the battery 200, and the battery 200 has a second terminal 211 corresponding to the first terminal 111, such that the image photographing apparatus 100 and the battery 200 are electrically connected.

A bottom surface of the battery mounting frame 110 is open to receive the battery 200 from the bottom in a sliding manner.

The battery mounting frame 110 and the battery 200 respectively have a guide member 300 for guiding the sliding movement of battery 200 and a locking member (not shown) for fixing the battery 200 at a position where the first and the second terminals 111 and 211 contact each other.

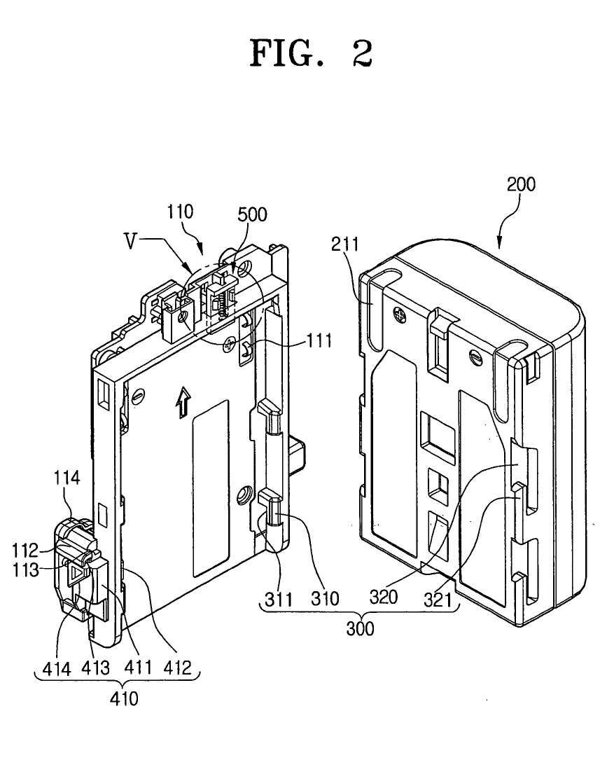

As shown in FIG. 2, the guide member 300 has a plurality of guide ribs 310 formed on the battery mounting frame 110 and rib grooves 320 correspondingly formed to the guide ribs 310 on the battery 200.

The guide rib 310 is received in the rib groove 320 as the battery 200 slides. The guide rib 310 has a latching jaw recess 311 at a bottom thereof for engagement with a battery latching jaw 321 formed at the rib groove 320.

By the sliding movement of the battery 200, the guide rib 310 and the rib groove 320 are engaged with each other, thereby restricting a sliding distance and guiding the sliding movement of the battery 200.

The locking member has a fixing member 410 mounted to the battery mounting frame 110 to appear and disappear according to a user's selection to restrict the sliding movement of the battery 200 and a sliding button 420 (FIG. 1A) for moving the fixing member 410.

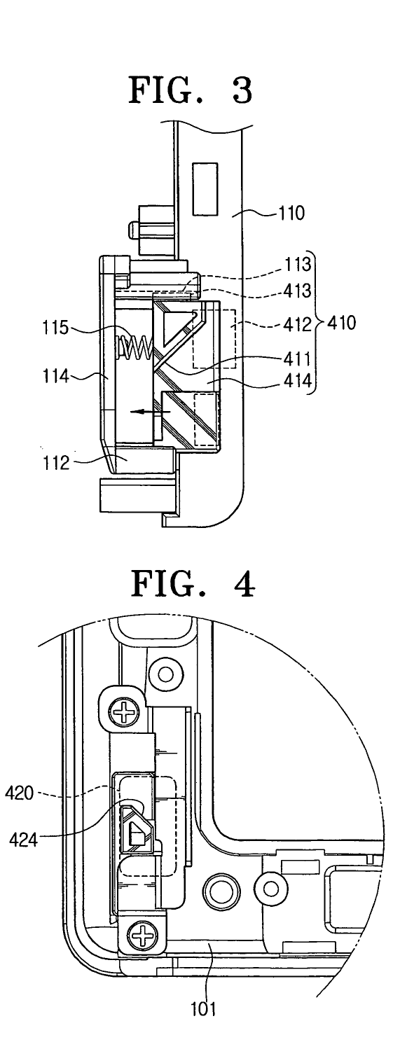

The fixing member 410 is elastically mounted to a fixing member holder 112, which is integrally formed with the battery mounting frame 110 to restrict the sliding movement of the battery 200, as being engaged with the rib groove 320. As shown in FIG. 3, the fixing member 410 is inserted in the fixing member holder 112 disposed at the rear side of the battery mounting frame 110. An opening where the fixing member 410 is inserted is closed by a holder cap 114, thereby preventing separation of the fixing member 410. An elastic member 115 is formed between the holder cap 114 and the fixing member 410 to elastically support the fixing member 410. The above-configured fixing member 410 is able to slide along an inner circumferential surface of the fixing member holder 112 according to the operation of the sliding button 420. To prevent deviation of the fixing member 410 during the sliding movement, a guide groove 113 for guiding the fixing member 410 is provided to the fixing member holder 112.

The fixing member 410 comprises a fixing member body 411, a fixing projection 412 integrally formed with the fixing member body 411 to restrict the sliding movement of the battery 200, a guide projection 413 sliding along the guide groove 113 and a first slope 414 contacting the sliding button 420 to move up and down the fixing member body 411 perpendicularly to the sliding direction of the sliding button 420.

FIG. 4 is an enlarged view of a part IV of FIG. 1A, showing the sliding button 420 from an inside thereof.

The sliding button 420 has a second slope 424 to engage the first slope 414. The sloping angle of the second slope 424 is substantially the same as that of the first slope 414. As the first and the second slopes 414 and 424 slide in contact with each other, the sliding button 420 having the second slope 424 moves only in the sliding direction whereas the fixing member 410 having the first slope 414 moves perpendicularly to the sliding direction of the sliding button 420. As a result, the fixing member 410 appears and disappears in a direction substantially perpendicular to the sliding movement of the sliding button 420.

Therefore, when the sliding button 420 is slid in a direction indicated by an arrow in FIG. 1, the fixing member 410 moves in a direction indicated by an arrow in FIG. 3. Therefore, the fixing projection 412 is depressed into the battery mounting frame 110. Accordingly, the sliding movement of the battery 200 is restricted.

At an upper part of the battery mounting frame 110, a switching unit 500 is provided to detect a position of the battery where the first and the second terminals 111 and 211 correspond to each other.

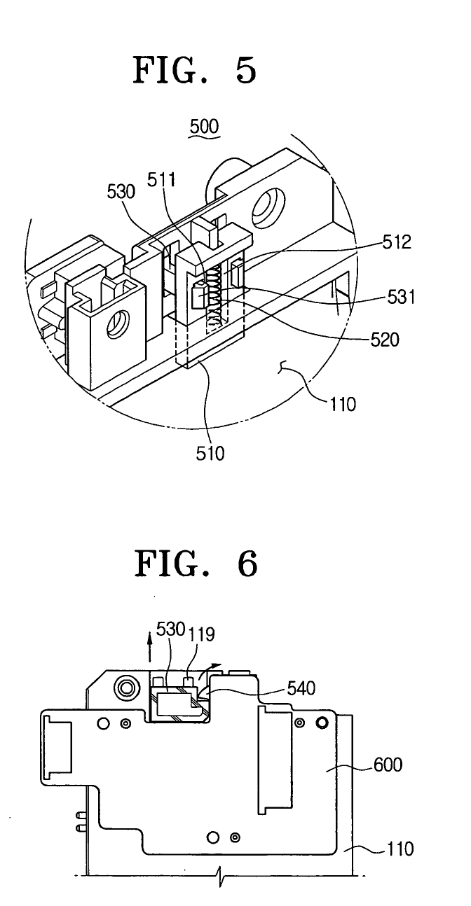

As shown in FIG. 5, the switching unit 500 has a sensor plate 510 vertically reciprocating depending on the sliding movement of the battery 200. A plate elastic member 520 elastically supports the sensor plate 410. A supporting bracket 530 fixes the sensor plate 510 and moves in association with the reciprocal movement of the sensor plate 510. A micro switch mounted on a circuit board 600 is connected to the rear side of the battery mounting frame 110 and is turned on and off by the supporting bracket 530.

The sensor plate 510 is fixed by the supporting bracket 530. The supporting bracket 530 has a fixing hook 531 and a fixing hook recess 511 formed to correspond to the fixing hook 531 to be engaged with the fixing hook 531.

One end of the sensor elastic member 520 is supported by the battery mounting frame 110 that guides a sliding movement of the sensor plate 510, and the other end is supported by an inner side of an elastic member receiving part 512 of the sensor plate 510.

The supporting bracket 530 supports the sensor plate 510, turns on and off the micro switch 540, and guides the sensor plate 510 sliding upwardly in contact with the battery 200. The fixing hook 531 is penetratingly connected where the supporting bracket 530 of the battery mounting frame 110 is mounted, and a fixing hook sliding hole 119 (FIG. 6) is formed for the fixing hook 531 to slide therethrough.

As shown in FIG. 6, when the battery 200 is mounted, and the sensor plate 510 is slid upwardly, the supporting bracket 530 also moves upwardly together with the sensor plate 510, thereby pushing the micro switch 540 for the operation.

The position of the battery 200 may be determined according to the on and off state of the micro switch 540. Therefore, when the image photographing apparatus 100 is connected to an external power to recharge the battery 200, if the battery 200 is separated or mounted, the switching unit 500 detects the separation or mounting to prevent the external power from being supplied to the first terminal 111. As a result, mishap such as electric shock may also be prevented.

Hereinbelow, the operation of the battery locking apparatus constructed as the above will be described with reference to the accompanying drawing figures.

As shown in FIG 1A, the battery 200 is detachably mounted to a rear portion of the image photographing apparatus 100. The battery 200 may be recharged by use of a dedicated recharging device or by direct connection with the external power, as being mounted to the image photographing apparatus 100.

If replacement of the battery 200 is required during use of the apparatus 100, a user may remove the exhausted battery 200 using one hand while the other hand is grabbing the image photographing apparatus 100.

For example, with the rest fingers and a palm of a right hand grabbing the battery 200, as a thumb of the right hand pushes the sliding button 420 upwardly (FIG 1A), as indicated by an arrow in FIG 1A, the rest fingers pull down the battery 200 in a gravity direction, thereby separating the battery 200.

Accordingly, the user can separate the battery 200 with only one hand by operating the sliding button 420 with the thumb. Furthermore, since the battery 200 is separated in the gravity direction, the weight of the battery 200 may help the user conveniently separate the battery 200.

As can be appreciated from the above description, due to the sliding button 420 disposed near the thumb of the right hand that usually grips the battery 200, the battery 200 may be safely released from the image photographing apparatus 100.

In addition, since the sliding button 420 is slid by the thumb of the hand holding the battery 200, the battery 200 may be separated in an easy manner with the thumb functioning as a supporting point.

While the invention has been shown and described with reference to certain embodiments thereof, it will be understood by those skilled in the art that various changes in form and details may be made therein without departing from the spirit and scope of the invention as defined by the appended claims.

1. A battery locking assembly, comprising
an electronic device;
a rechargeable battery detachably mounted to the electronic device; and
a battery locking apparatus to lock and release the rechargeable battery that is detachably mounted to the electronic device by a sliding operation of a sliding button, wherein releasing directions of the sliding button and the battery are opposite to each other.

2. The battery locking assembly of claim 1, wherein
the rechargeable battery is mounted to a rear side of the electronic device and separated in a gravity direction.

3. The battery locking assembly of claim 1, wherein
the electronic device is an image photographing apparatus.

4. A battery locking apparatus, comprising:
a plurality of guide ribs protruding on a battery mounting frame connected to one side of an electronic device;
a plurality of rib grooves formed in a battery corresponding to the guide ribs to be slidably engaged with the guide ribs;
a fixing member formed at the battery mounting frame to appear and disappear by a user's selection, thereby restricting a sliding movement of the battery; and
a sliding button for moving up and down the fixing member,
wherein to separate the battery the sliding button is slid in the opposite direction to a releasing direction of the battery.

5. The battery locking apparatus of claim 3, wherein
the fixing member is elastically supported by a fixing member holder to slide according to the operation of the sliding button.

6. The battery locking apparatus of claim 5, wherein
the fixing member holder is integrally formed with the battery mounting frame.

7. The battery locking apparatus of claim 5, wherein
the fixing member holder has a guide groove to guide the sliding movement of the fixing member.

8. The battery locking apparatus of claim 7, wherein
the fixing member has a fixing member body;
a fixing projection is integrally formed with the fixing member body to restrict the sliding movement of the battery;
a guide projection sliding along the guide groove; and
a first slope contacting the sliding button to move up and down the fixing member body in a perpendicular direction to the movement of the sliding button.

9. The battery locking apparatus of claim 8, wherein
the sliding button has a second slope to contact the first slope.

10. The battery locking apparatus of claim 9, wherein
the first and second slopes have substantially similar angles.

11. The battery locking apparatus of claim 4, wherein
the battery mounting frame has a switching unit to detect if the battery is mounted.

12. The battery locking apparatus of claim 11, wherein
the switching unit has a sensor plate adapted to move vertically as the battery slides;
a sensor elastic member elastically supports the sensor plate;
a supporting bracket fixes the sensor plate and moves in association with the reciprocation of the sensor plate; and
a micro switch mounted on a circuit board that is connected to a rear side of the battery mounting frame and turned on and off by the supporting bracket.
